(19) United States
(12) Patent Application Publication
(10) Pub. No.: US 2003/0017099 A1
(43) Pub. Date: Jan. 23, 2003

(54) Sodium bicarbonate production method

(75) Inventor: Andrew D. Kurtz, Belle Mead, NJ (US)

Correspondence Address: Irving M. Fishman, Esquire, Church & Dwight Co., Inc., 469 North Harrison Street, Princeton, NJ, 08543, US

(73) Assignee: Church & Dwight Co., Inc.

(21) Appl. No.: 09/910,540

(22) Filed: Jul. 20, 2001

(51) Int. Cl. C01D 7/10

(52) U.S. Cl. 423/422

(57) ABSTRACT

A method of producing additional sodium bicarbonate having a high degree of purity and obtaining a net reduction in effluent waste water, as compared to prior processes, when starting from trona ore is disclosed. The process entails utilizing the waste-water effluent stream from the conversion of trona ore to sodium carbonate as the feed for the conversion of sodium carbonate to sodium bicarbonate.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF THE INVENTION

The invention relates to processes for the production of sodium bicarbonate, sodium carbonate, and sodium carbonate decahydrate. It also relates to obtaining additional desired product from a given weight of ore. It further relates to reduction of waste water from commercial production facilities.

### BACKGROUND OF THE INVENTION

The commercial production of sodium bicarbonate generally begins with the mining of trona ore, which is processed in “soda” plants to produce sodium carbonate. The desired product of that production is a high quality and fairly pure sodium carbonate product. The production plant does have however an effluent volume that contains about 30% of dissolved sodium carbonate, in addition to significant amounts of dirt and other contaminants. In normal sodium bicarbonate production the pure sodium carbonate product is then converted to sodium bicarbonate in a separate plant. The conversion of the carbonate to bicarbonate is typically done in a “no waste-water effluent” manner.

Over the years, commercial waste-water production has been severely curtailed by governmental action. First, water use demand needs to be kept low in commercial processes (where possible) so as to allow for adequate supplies for personal use and for commercial use that cannot be further reduced. Second, effluent water must be treated before being released into the environment so as to have as little an impact on the environment as possible. Unfortunately, waste-water treatment facilities are limited by both the volume of waste-water they can handle and the contaminants which might be in the waste-water. For these reasons, there has been severe governmental pressures to keep the volume of waste-water from commercial facilities to as low an amount as possible. In this vein, the amount of waste-water which can be discharged by a commercial plant is heavily regulated and subject to governmental permits.

Therefore, processes that allow for a reduction of effluent waste-water over current commercial production processes are highly sought after.

In addition, as non-renewable natural resources, such as mined ore, are used, there becomes an ever increasing need to extract more and more desired product from the production line using the same amount of starting ore. It would be highly desired to recover any significant amount of additional product without having to mine additional ore.

To achieve both additional production of desired product and simultaneously reduce effluent waste-water is a truly prized situation that is desired in any commercial process.

### OBJECTS OF THE INVENTION

It is therefore an object of the invention to provide a process for the production of sodium bicarbonate (beginning with mined trona ore) that produces less effluent waste-water than current processes.

It is also an object of the invention to provide a process for the production of sodium bicarbonate that allows for greater recovery of sodium as carbonate and/or bicarbonate per unit weight of trona ore than previously used processes.

It is yet another object of the invention to obtain an end product which, despite utilizing a less pure feed than prior processes, is of the same or even greater purity than the product resulting from the prior processes.

Other objects of the invention will be apparent to those of ordinary skill in the art.

### BRIEF SUMMARY OF THE INVENTION

These and other objects of the invention can be achieved by utilizing the waste-water effluent stream of a sodium carbonate manufacturing facility (hereinafter stream A) as a feed for sodium carbonate decahydrate production. The sodium carbonate decahydrate product (crystal, typically containing 63% water and 37% sodium carbonate) is then used as the feed for a sodium bicarbonate production process. While there is an ultimate effluent from the sodium carbonate decahydrate production (waste-water stream C) and from the sodium bicarbonate production (waste-water stream B) steps, the total amount of stream B plus stream C is less than the stream A utilized for the sodium carbonate decahydrate production feed. Thus there is a net reduction in waste-water effluent, and an improvement in recovered sodium value, over the prior processes. A further surprising result is that the purity of the resulting sodium bicarbonate is as good as or even better than from the prior process, even though the sodium carbonate feeding the plant is not as pure as the soda ash used formerly.

### BRIEF DESCRIPTION OF THE SEVERAL VIEWS OF THE DRAWING

FIG. 1 is a block diagram of the prior art process of making sodium bicarbonate from trona ore through an anhydrous sodium carbonate (soda ash) intermediate.

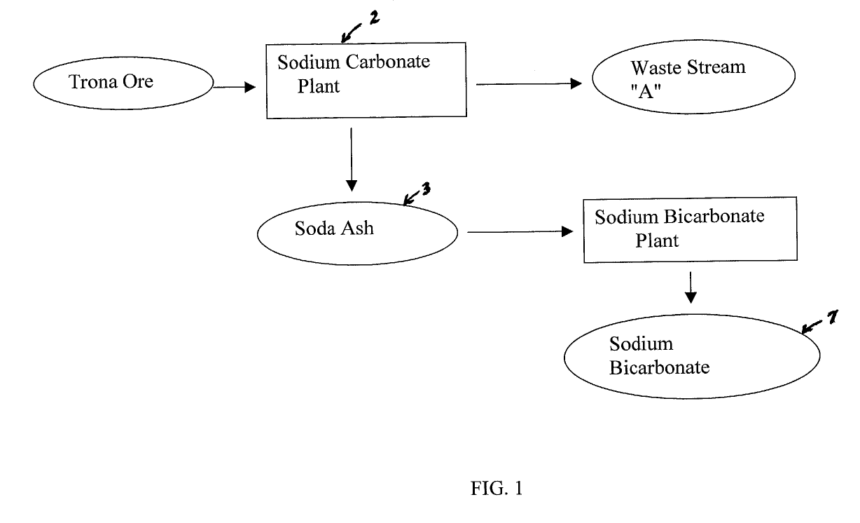

FIG. 2 is a block diagram of the present invention which utilizes the waste stream from the production of soda ash to produce additional sodium bicarbonate and/or sodium carbonate through a sodium carbonate decahydrate intermediate.

### DETAILED DESCRIPTION OF THE INVENTION

The present invention is the achievement of a number of goals, all of which may be achieved separately or simultaneously. In essence, the invention is the use of a waste-water effluent stream (A) from a sodium carbonate production process as a feed for a process which converts sodium carbonate ultimately into sodium bicarbonate. This waste-water stream (A) typically contains significant amounts of unrecovered sodium value. The otherwise recovered sodium carbonate can be used as sodium carbonate for the usual purposes.

Because of regulatory factors to keep waste-water effluent streams as low as possible, the usual conversion of purified sodium carbonate to sodium bicarbonate has been practiced by methods that have a zero waste-water effluent stream. The use of the effluent stream (A), because it contains water, necessarily means that there will be a waste-water effluent stream in any process which utilizes it as a feed source. However, the total amount of waste-water effluent stream produced in the conversion of the sodium carbonate contained in the effluent stream (A) is surprisingly less than the amount of effluent stream (A) consumed as a feed source.

In addition, the effluent stream (A) contains a large number of contaminants that would be expected to carry over in some part into the sodium bicarbonate product. Since sodium bicarbonate is frequently used in food and pharmaceutical products and in very sensitive electronic component cleaning products, etc., high purity is an absolute necessity for commercially produced sodium bicarbonate. Therefore, introduction of any contaminants in excess of that present in current commercially produced materials is not suitable. Surprisingly, despite the presence of substantially greater contamination by a host of contaminants in the stream (A) not significantly present in the pure or substantially pure sodium carbonate used as the typical feed for a sodium carbonate to sodium bicarbonate conversion process, the product resulting from the inventive process using the stream (A) as a feed for a sodium carbonate to sodium bicarbonate conversion process is at least as pure, and generally purer than the sodium bicarbonate produced by the current non-effluent waste-water sodium carbonate to sodium bicarbonate production process.

As the first step in the process, any conversion of trona ore to sodium carbonate process can be used as long as it produces a waste-water effluent stream which has unrecovered sodium carbonate dissolved therein. The typical trona ore to sodium carbonate processes are known in the art as seen from: “Sodium Carbonate,” Kirk Othmer Encyclopedia of Chemical Technology, 4^{th} Ed., Vol. 1, 1991.

The effluent waste-water stream (A) resulting from the conversion of trona ore to sodium carbonate (which contains additional sodium carbonate dissolved therein) is used as is as a liquid feed into a process for the conversion of a portion of the sodium carbonate dissolved therein into sodium carbonate decahydrate. This “decahydrate process” produces crystals of sodium carbonate decahydrate, which are then fed directly to the sodium bicarbonate plant. The sodium carbonate decahydrate process also has some waster-water liquor, typically referred to as bitterns, but the sum of these bitterns and the waste-water from the sodium bicarbonate process (further downstream) will be less than the original stream A consumed.

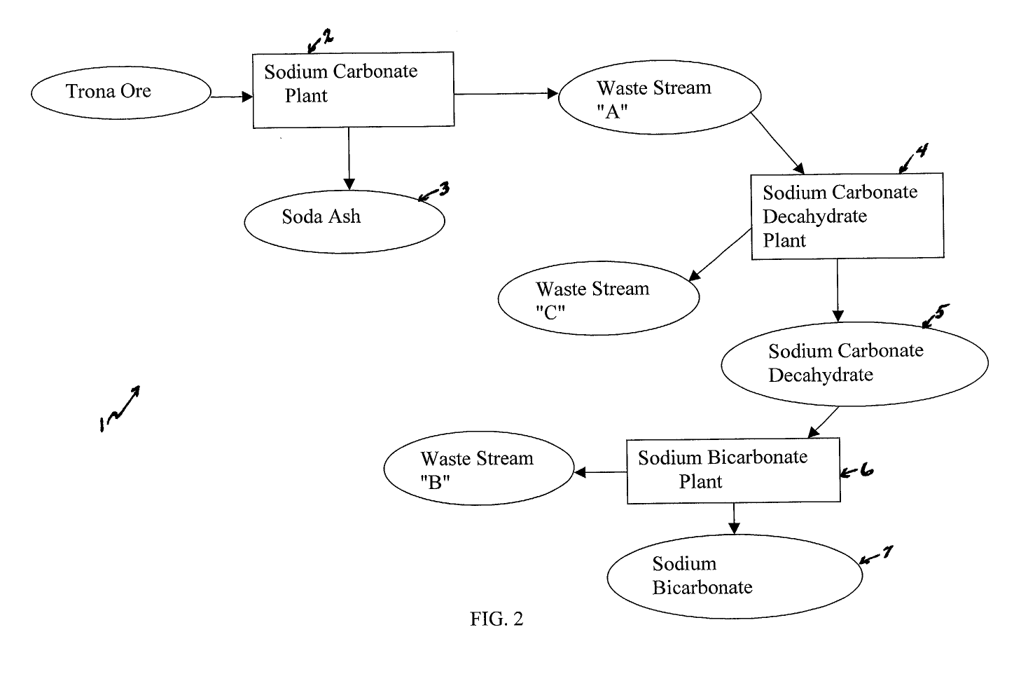

The process of the invention is illustrated in FIG. 2, where the entire process 1 is composed of three substeps, linked together as shown. Trona ore is fed into sodium carbonate process 2 which produces sodium carbonate crystal product 3 and effluent waste-water stream A. Stream A is fed into sodium carbonate to sodium carbonate decahydrate conversion plant 4 which produces sodium carbonate decahydrate crystals 5 and waste-water stream C. Sodium carbonate decahydrate crystals 5 are fed into sodium carbonate decahydrate to sodium bicarbonate conversion plant 6, with the production of sodium bicarbonate 7 and waste-water stream B. Both streams B and C contain additional still unrecovered sodium value and may be utilized as had been stream A in the past or either or both may be recycled into sodium carbonate to sodium carbonate decahydrate conversion plant 4 (with or without removal of solids as desired and with or without degassing of carbon dioxide, as may be desired).

### EXAMPLES

The following examples are intended only to exemplify the invention by way of example and are not intended to limit the scope of the claimed invention.

### Example 1

The existing state of the art in the production of sodium bicarbonate from trona ore is set forth, followed by the instant invention. A mono process plant refines trona ore, ultimately producing a purge (waste-water) stream containing 30% dissolved sodium carbonate as well as a product stream of dry, commercial soda ash, some of which is used in a sodium bicarbonate plant to produce sodium bicarbonate. In the sodium bicarbonate plant, there is no purge and the conversion of soda ash to sodium bicarbonate yields virtually 100% recovery. The waste-water purge, however, is disposed of in evaporation ponds, or some may be sold locally for opportunistic uses at a very low price.

Example of the Present Invention:

To the above situation a decahydrate plant is added. This decahydrate plant receives the purge from the existing mono process soda ash plant as feed. The decahydrate process is essentially nothing more than a crystallizer, recovering much of the dissolved sodium carbonate as the solid decahydrate of sodium carbonate and yielding its own purge, called bitterns. The decahydrate crystals are fed to the existing sodium bicarbonate plant instead of the refined soda ash formerly fed thereto. The sodium bicarbonate plant runs more or less normally, except the added water fed (note that decahydrate is 63% water and 37% sodium carbonate) necessitates a waste-water purge stream from the sodium bicarbonate plant. At first glance, this purging of a sodium bicarbonate plant is unappealing, but in fact the net purging required with this new technology is less than that required in the prior art, as follows:

For each pound of the waste-water stream consumed as feed into the decahydrate process according to the new process, there is generated 0.353 pounds of bitterns from the decahydrate process and 0.455 pounds of waste-water purge from the sodium bicarbonate process. Thus, total purging overall is 0.808 pounds, which is a reduction of about 19%. Furthermore, the amount of sodium value lost through purging is reduced by about ½, because the bitterns purge contains only 19% sodium carbonate and the sodium bicarbonate process purge contains 14% sodium carbonate equivalent.

A further application of the concept adds the recycling of the sodium bicarbonate purge back to the feed of the decahydrate plant, so that there is only one net purge, the bitterns stream. This bitterns purge would be somewhat larger, but still less than even the improved case described above.

I/we claim:

1. A method of obtaining a purified sodium bicarbonate comprising:
utilizing a sodium carbonate containing effluent waste-water stream (stream A) from a sodium carbonate production process as a feed stream in a sodium bicarbonate production process.

2. The method of claim 1 wherein said stream A is used as a feed to first extract sodium carbonate decahydrate and said sodium carbonate decahydrate is used as the feed stream for said sodium bicarbonate production process.

3. The method of claim 2 wherein said sodium bicarbonate production process also produces a waste-water effluent stream (stream B), and wherein said sodium carbonate decahydrate extraction produces a waste-water effluent stream (stream C) wherein the total of effluent waste-water streams B and C is less than the amount of said stream A consumed.

4. The method of claim 1 wherein said sodium bicarbonate is of greater purity than sodium bicarbonate produced by a non-waste-water effluent stream B sodium bicarbonate production process.

5. A method of increasing the production of sodium bicarbonate and/or sodium carbonate recovered per unit of trona ore mined comprising:
a) converting said trona ore into sodium carbonate (1) with the concomittant production of a waste-water effluent stream (stream A) containing additional sodium carbonate (2);
b) optionally converting said sodium carbonate (1) into sodium bicarbonate; and
c) separately utilizing said waste-water effluent stream (A) containing additional sodium carbonate (2) as a feed stream for a conversion of sodium carbonate to sodium carbonate decahydrate, whereby a portion of the sodium carbonate contained in stream A is recovered as sodium carbonate decahydrate; and
d) optionally converting said sodium carbonate decahydrate to additional sodium bicarbonate and recovering said additional sodium bicarbonate.

6. A high purity sodium bicarbonate resulting from the process of claim 1, wherein said high purity is at least as great as that produced from a non-waste-water effluent sodium bicarbonate production process.

7. A method of reducing waste-water effluent stream production in the conversion of trona ore to sodium bicarbonate comprising:
first converting said trona ore into sodium carbonate with the concomitant production of a waste-water effluent stream (stream A) containing additional sodium carbonate; and utilizing said waste-water effluent stream A as a feed stream for a process of converting sodium carbonate into sodium carbonate decahydrate with the concomitant production of a downstream waste-water effluent stream C, and converting said sodium carbonate decahydrate to sodium bicarbonate with the concomitant production of a downstream waste-water effluent stream B, whereby the total amount of waste-water effluent stream from B and C produced is less than the amount of stream A consumed.
